(19) United States
(12) Patent Application Publication
(10) Pub. No.: US 2002/0112080 A1
(43) Pub. Date: Aug. 15, 2002

(54) Universal peripheral device controller

(76) Inventors: Anthony L. Millin, Tenafly, NJ (US); Scott G. Van Sickle, Hewitt, NJ (US); Alexander D. Boyce, Oakland, NJ (US); David Grossberg, Miami Beach, FL (US)

Correspondence Address: PENNIE AND EDMONDS, 1155 AVENUE OF THE AMERICAS, NEW YORK, NY, 100362711

(21) Appl. No.: 09/781,180

(22) Filed: Feb. 12, 2001

(51) Int. Cl. G06F 15/16

(52) U.S. Cl. 709/246; 709/237

(57) ABSTRACT

A preferred embodiment of the present invention comprises a software plug-in that allows a peripheral device to communicate via a host (e.g., a personal computer) with a remote server through a communications port. The plug-in is preferably downloaded from the remote server and allows the peripheral device to communicate with that server or other remote servers, and the remote servers are able to communicate and control the peripheral device without any additional software being installed to the host.

### FIELD OF THE INVENTION

The present invention relates to sending information from a portable device to a remotely-located computer. More specifically, it relates to data transmission from a computer peripheral device over the Internet to a web server.

### BACKGROUND

Most device communication systems require that custom software, drivers, and/or user interfacing software be installed on a personal computer (PC) in order to allow a peripheral device, such as a Palm Pilot, digital pad, or other peripheral device to communicate with the PC. In order for the peripheral device to transfer data to a remotely-located computer, such as a server, the peripheral device must first transfer the data to a local PC or other computer that has had the required custom software, drivers, and/or user interfacing software installed.

The necessity of installing customized software, drivers and user interface software onto a PC to enable a peripheral device to communicate with that PC or remotely-located PCs or servers creates problems. Excess memory is used, interference with other software can occur, upgrades need to be installed on the PC, the software has to be maintained, conflicts between drivers can develop, as well as conflicts between COM ports and other conflicts between the software required to run the peripheral device and software that runs on the PC for other purposes.

Moreover, whenever a user desires to transfer information from a peripheral device to a remotely-located computer, the user must either find a PC that has had the appropriate software installed or bring the software along so that he can install it on the nearest PC. What is needed is a method and system for transferring data from a peripheral device to a remote computer that is independent of what software is installed on a local PC or other device used to link the peripheral device to the Internet.

### SUMMARY

A preferred embodiment of the present invention comprises a software plug-in that allows a peripheral device to communicate via a host (e.g., a personal computer) with a remote server through a communications port. The plug-in is preferably downloaded from the remote server and allows the peripheral device to communicate with that server or other remote servers, and the remote servers are able to communicate and control the peripheral device without any additional software being installed to the host.

### BRIEF DESCRIPTION OF THE DRAWINGS

FIG. 1 depicts two potential configurations of a preferred system.

FIG. 2 is a flowchart showing preferred functionality of software of a preferred embodiment of the present invention.

### DETAILED DESCRIPTION OF PREFERRED EMBODIMENTS

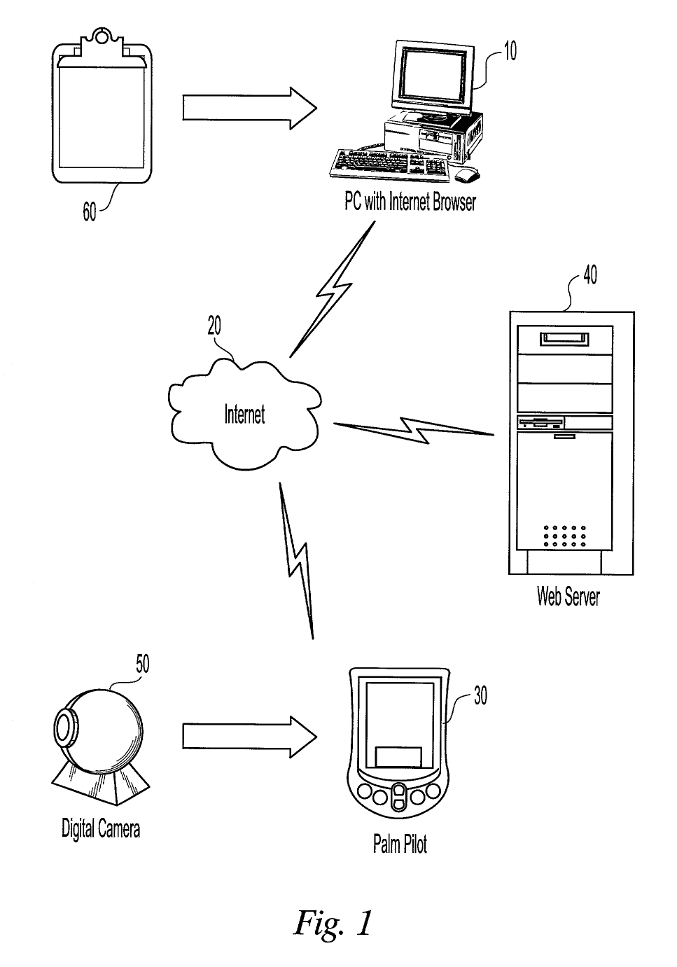

FIG. 1 depicts two potential configurations of a preferred system. In a preferred embodiment, a user attaches a peripheral device, such as a digital camera 50 or a digitizer pad 60, to a communications port (whether on a PC 10, a Web Phone, an Internet-enabled Palm Pilot 30 or another Internet access device) and then uses a web browser to access a system web server 40.

Upon connecting to the system web server 40, the user downloads a plug-in to the PC 10, for example, that allows the peripheral device to communicate to the remote server 40 through the communications port. Herein, the terms “plug-in” and “plug-in computer program” include software such as a browser plug-in, a PRC (also known as a “Palm Resource” or “Palm Application”), or an ActiveX Control.

The plug-in allows the peripheral device to communicate with remote servers of the system and the remote servers are able to communicate with and control the peripheral device. Source code for a browser plug-in written in the C++ programming language and that uses the Netscape Plug-in Application Programming Interface (API) for running on Windows platforms is included in the Appendix at the end of this description.

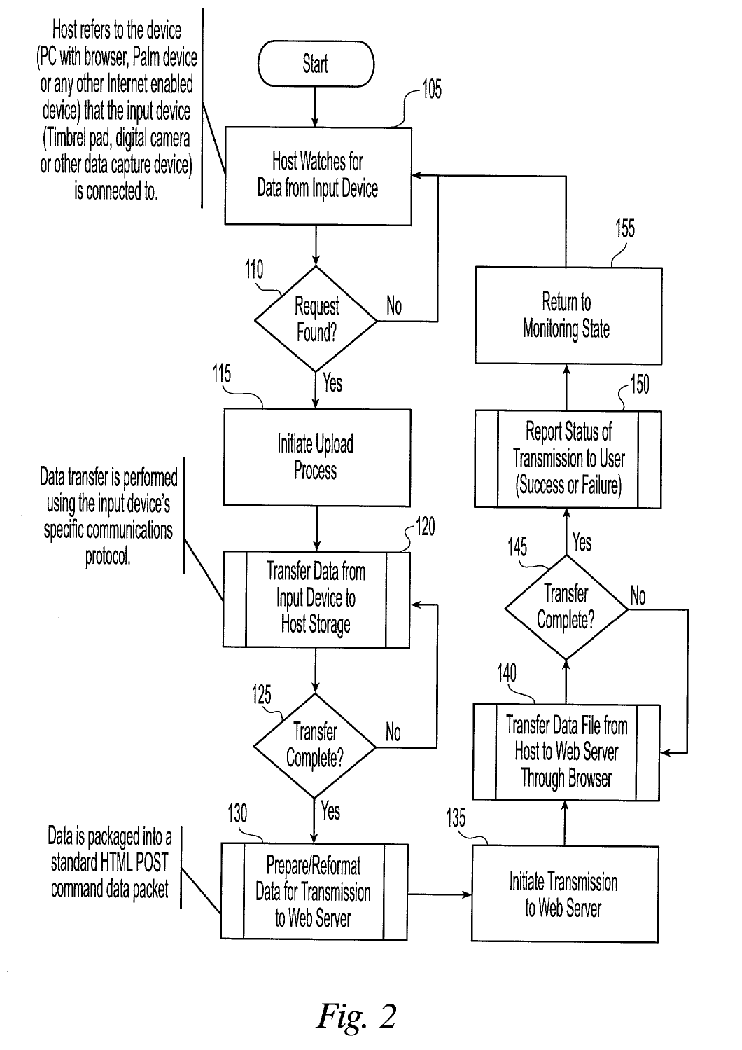

FIG. 2 is a flowchart showing preferred functionality of the plug-in and steps of a preferred method. A host is a device (PC with browser 10, Internet-enabled Palm device 30, or other Internet-enabled device) that an input device (peripheral device—e.g., digitizer pad 60, digital camera 50, non-Internet-enabled Palm Pilot) is connected to via a communications port of the host. As used herein, the term “communications port” includes an RS-232 serial port, a USB port, an infrared port, or a Bluetooth port. Thus, the term “input device” does not include a keyboard or a mouse. In the following description, the actions of the host are controlled by a plug-in that has preferably been downloaded over the Internet. At step 105 a host watches for data from an input device. At step 110 the host checks whether a request from the input device to upload data has been detected. If not, the host continues at step 105 to watch for data from the input device.

If at step 110 a request from the input device to upload data has been detected, then at step 115 the host initiates an upload process, and at step 120 data is transferred from the input device to the host's data storage. The data transfer is performed using the input device's specific communications protocol. This protocol is utilized by the plug-in. In a preferred embodiment, a different plug-in is used for each different communications protocol. In an alternate embodiment, a single plug-in comprises software to enable communications with a plurality of devices that use a plurality of different communications protocols.

At step 125, the host checks whether the data transfer is complete. If not, then step 120 is repeated and/or continued, as appropriate. If at step 125 data transfer is complete, then at step 130 the host prepares the received and stored data for transmission to a system web server 40. The data may be reformatted at this step. Preferably, it is packaged into a standard HTML POST command data packet.

At step 135, the host initiates transmission of the received and stored data to a system web server 40. At step 140 the data is transferred from the host to the web server 40 through a browser installed on the host and the web server 40. The data is transferred to the system web server 40 using an API provided by the browser.

At step 145 the host checks whether the data transfer to the web server 40 is complete. If not, then step 140 is continued or repeated, as appropriate. If at step 145 the data transfer is complete, then at step 150 the host reports the status of the data transmission to the user (success or failure). At step 155 the host returns to a monitoring state and repeats step 105.

Although the present invention has been described with respect to input devices such as digitizer pads and digital cameras, and Internet-enabled devices such as PCs with browsers and Internet-enabled Palm Pilots or other personal digital assistants (PDAs), those skilled in the art will recognize that the invention may be used to transmit data from any input device to a web server, if the input device is configured to transmit data to a PC or other device that can be connected to the Internet.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A plug-in computer program stored on a local host computer for transferring data between an input device and a remotely-located computer that is connected to said local host computer by a computer network, comprising:
(a) software for receiving data from said input device;
(b) software for formatting said received data so that it can be transferred over said computer network to said remotely-located computer; and
(c) software for transmitting said received data to said remotely-located computer over said computer network.

2. A computer program as in claim 1, wherein said computer network is the Internet and said remotely-located computer is a web server.

3. A computer program as in claim 1, wherein said input device is a digitizer pad.

4. A computer program as in claim 1, wherein said input device is a digital camera.

5. A computer program as in claim 1, wherein said local host computer is an Internet-enabled computer connected to said remotely-located computer via the Internet.

6. A computer program as in claim 5, wherein said program is a browser plug-in.

7. A computer program as in claim 1, wherein said host computer is an Internet-enabled personal digital assistant.

8. A computer program as in claim 7, wherein said plug-in computer program is a PRC.

9. A computer program as in claim 6, wherein said browser plug-in is downloaded to said local host computer via the Internet.

10. A computer program as in claim 6, wherein said browser plug-in comprises software that enables communication based on a communications protocol specific to the input device.

11. A computer program as in claim 1, wherein said formatted data is packaged into an HTML POST command data packet.

12. A system for transmitting data, comprising:
(a) an input device; and
(b) a host computer; wherein said input device is configured to transmit data to said host computer, and wherein said host computer is connected to a computer network and stores a plug-in computer program that comprises:
(i) software for receiving data from said input device;
(ii) software for formatting said received data so that it can be transferred over said computer network to said remotely-located computer; and
(iii) software for transmitting said received data to said remotely-located computer over said computer network.

13. A system as in claim 12, wherein said computer network is the Internet.

14. A system as in claim 12, wherein said input device is a digitizer pad.

15. A system as in claim 12, wherein said input device is a digital camera.

16. A system as in claim 12, wherein said host computer is an Internet-enabled computer connected to a remotely-located computer via the Internet.

17. A system as in claim 12, wherein said host computer is an Internet-enabled personal digital assistant.

18. A system as in claim 17, wherein said plug-in computer program is a PRC.

19. A system as in claim 16, wherein said computer program is a browser plug-in.

20. A system as in claim 19, wherein said browser plug-in is downloaded to said host computer via the Internet.

21. A system as in claim 19, wherein said browser plug-in comprises software that enables communication based on a communications protocol specific to the input device.

22. A system as in claim 12, wherein said formatted data is packaged into an HTML POST command data packet.

23. A method of transmitting data from an input device to a remotely-located computer, comprising the steps of:
(a) establishing a communication link between a local host computer and said remotely-located computer over a computer network using a network browser;
(b) establishing a communication link between said input device and said local host computer;
(c) receiving data from said input device;
(d) formatting said received data so that it can be transferred over said computer network to said remotely-located computer; and
(e) transmitting said received data to said remotely-located computer over said computer network, wherein said steps of receiving data, formatting data, and transmitting data are performed using a plug-in computer program.

24. A method as in claim 23, wherein said computer network is the Internet.

25. A method as in claim 23, wherein said input device is a digitizer pad.

26. A method as in claim 23, wherein said input device is a digital camera.

27. A method as in claim 23, wherein said plug-in is downloaded to said host computer via the Internet.

28. A method as in claim 23, wherein said host computer is an Internet-enabled personal digital assistant.

29. A method as in claim 28, wherein said plug-in computer program is a PRC.

30. A method as in claim 23, wherein said plug-in comprises software that enables communication based on a communications protocol specific to the input device.

31. A method as in claim 23, wherein said formatted data is packaged into an HTML POST command data packet.
